(19) United States
(12) Patent Application Publication
(10) Pub. No.: US 2026/0079039 A1
(43) Pub. Date: Mar. 19, 2026

(54) LIQUID LEVEL DETECTOR SYSTEM

(71) Applicant: Chem-Enomics LLC, Charlotte, NC (US)

(72) Inventors: Shannon HUGHES, Charlotte, NC (US); Arthur RIDDLE, Tryon, NC (US); Jason BURKHART, Lexington, NC (US)

(21) Appl. No.: 19/332,308

(22) Filed: Sep. 18, 2025

Related U.S. Application Data
(60) Provisional application No. 63/696,580, filed on Sep. 19, 2024.

(51) Int. Cl. G01F 23/68; G01F 23/292; G01F 23/76

(52) U.S. Cl. CPC G01F 23/686; G01F 23/292; G01F 23/76

(57) ABSTRACT

Systems and methods for detecting a liquid height level within a container include a stationary platform for positioning at a fixed position, a floating platform for floating proximate a surface level of a liquid, and a processor for calculating a height level of the liquid. The floating platform includes at least one pair of light-projecting devices for projecting toward the stationary platform and the stationary platform includes a light-receiving surface for reception of the projected light thereon, a light-sensing element for detection of light incident upon the light-receiving surface, and circuitry for generating light-detection signals based on the detection of light incident upon the light-receiving surface. The processor is configured to determine, based on the light-detection signals, the height level of the liquid.

### FIELD OF THE INVENTION

The present disclosure relates to an apparatus and method for measuring fluid levels in closed containers. In particular, the present disclosure is directed to self-contained fluid level sensors adapted for use in sealed fluid containers.

### BACKGROUND OF THE INVENTION

Fluid level sensors are regularly used to determine the remaining volume of a stored fluid (e.g., fuel, coolant, lubricant, water, etc.). However, conventional fluid level sensors may provide erroneous results, for example, when a signal transmitting unit is not properly aligned with a signal receiving unit. Thus, there remains a need for improvements to the art.

### SUMMARY OF THE INVENTION

Systems and methods for detecting a liquid height level within a container include a stationary platform for positioning at a fixed position, a floating platform for floating proximate a surface level of a liquid, and a control unit (processor) for calculating a height level of the liquid. The floating platform includes at least one pair of light-projecting devices for projecting toward the stationary platform and a light sensor configured for activating power to the at least one pair of light-projecting devices. The stationary platform includes a number of light-emitting devices for emitting light for detection by the light sensor at the floating platform to trigger activation of the at least one pair of light-projecting devices, a light-receiving surface for reception of the projected light thereon, a light-sensing element for detection of light incident upon the light-receiving surface, and circuitry for generating light-detection signals based on the detection of light incident upon the light-receiving surface.

The processor is configured to determine, based on the light-detection signals, a height level of a liquid. The processor may be provided at a control unit of the stationary platform or at a remote system. When the processor is provided at a remote system, a control unit of the stationary platform is configured to communicate output data comprising the light-detection signals to the remote processing unit. When using a remote processing unit, that remote processing unit may receive output data from the control units of multiple stationary platforms in multiple liquid level detection systems within multiple liquid holding containers.

The processor is configured to use light-detection signals from the light-sensing element to determine a distance between a first projected light incident on the light-receiving surface and a second projected light incident on the light-receiving surface. The processor then uses the distance between incidence of the first projected light and incidence of the second projected light to determine a distance between the stationary platform and the floating platform. The processor then uses the distance between the stationary platform and the floating platform to determine the liquid height level based on a predetermined height between the light-receiving surface and a bottom of an internal liquid storage volume.

Both the foregoing general description and the following detailed description are exemplary and explanatory only and are intended to provide further explanation of the invention as claimed. The accompanying drawings provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 shows a container with a liquid level detector (LLD) system according to the invention inserted therein.

FIGS. 2a-2b shows an example of the LLD system from FIG. 1, with FIG. 2a showing the LLD system with a head and duct in an engaged state and FIG. 2b showing the LLD system with the head and duct in a disengaged state.

FIG. 3 shows a bottom plan view of a stationary platform in the LLD system of FIG. 1.

FIG. 4 shows a top plan view of a floating platform in the LLD system of FIG. 1.

FIGS. 5a-5b show the LLD system of FIG. 1 at the time of a first measurement, with: FIG. 5a showing a height level of the liquid and a distance between the stationary platform and the floating platform; and FIG. 5b showing a corresponding distance between a pair of projected lights incident upon the light-receiving surface of the stationary platform.

FIGS. 6a-6b show the LLD system of FIG. 1 at the time of a second measurement, with: FIG. 6a showing a height level of the liquid and a distance between the stationary platform and the floating platform; and FIG. 6b showing a corresponding distance between a pair of projected lights incident upon the light-receiving surface of the stationary platform.

FIGS. 7a-7b show the LLD system of FIG. 1 at the time of a third measurement, with: FIG. 7a showing a height level of the liquid and a distance between the stationary platform and the floating platform; and FIG. 7b showing a corresponding distance between a pair of projected lights incident upon the light-receiving surface of the stationary platform.

FIG. 8 shows results from LLD system according to the present invention.

FIG. 9 shows a plurality of LLD systems according to FIG. 1 communicating with a remote processing unit and a remote database through a routing device.

### DETAILED DESCRIPTION OF THE INVENTION

The following disclosure discusses the present invention with reference to the examples shown in the accompanying drawings, though does not limit the invention to those examples.

The use of examples or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

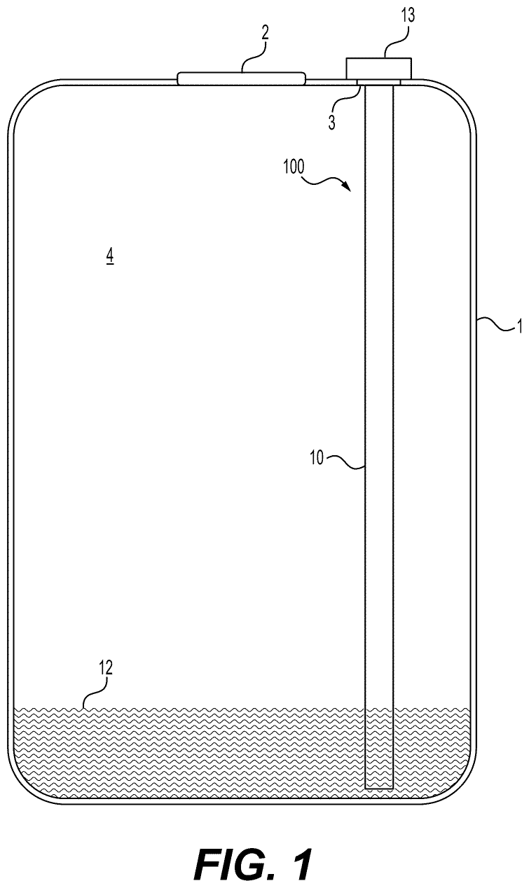

A liquid level detector (LLD) system measures a liquid level, and optionally other relevant data, within a closed container and wirelessly transmits the measurements to a remote system, such as a processing unit (e.g., a workstation) and/or a remote database (e.g., a cloud-based sever) such as an Amazon Web Services (AWS) server, for collection and analysis. FIG. 1 shows an example of a container 1 with an LLD system 100 inserted therein. Container 1 a primary opening 2 for filling and/or removing a liquid 12 in a storage volume 4 and a secondary opening 3 for accessing the storage volume 4. In some examples, container 1 may include more openings and in some examples container 1 may include a single opening that serves both purposes of the primary and secondary openings. LLD system 100 is dimensioned for insertion into the storage volume 4 of the container 1 through the secondary opening 3. Optionally, container 1 and system 100 may be provided with a mating fasteners that enable a secure engagement therebetween (e.g., mating threaded tracks). The LLD system 100 is adapted to measure a liquid level L of the liquid 12 held within the storage volume 4 and communicate the collected data to the remote system, for example, through the internet via a routing device (e.g., a Wi-Fi or ethernet connection). Data collected at the remote system is available for storage, analysis, and access through a user interface, such as a web browser on a personal computer or a mobile device.

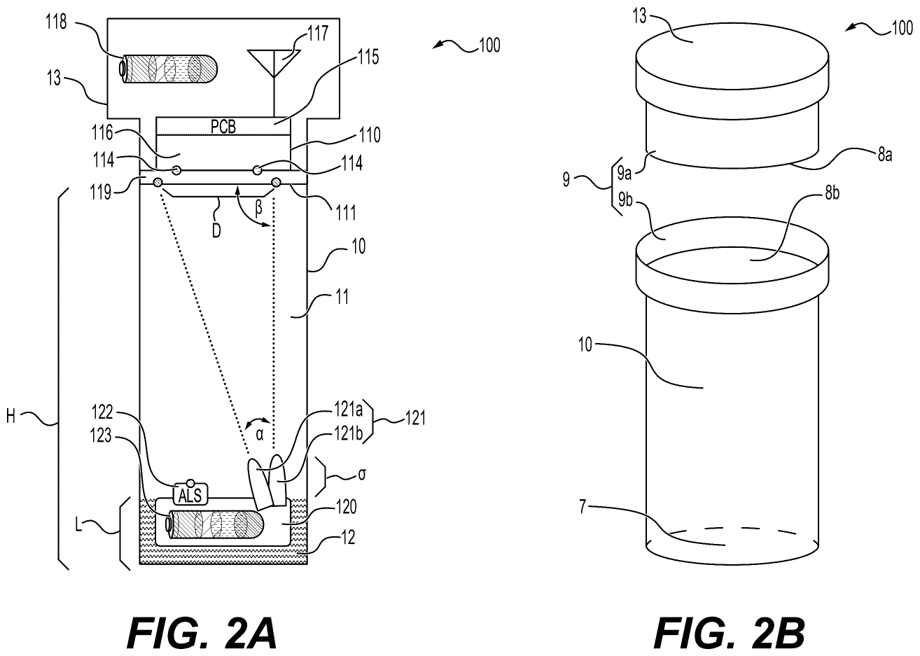

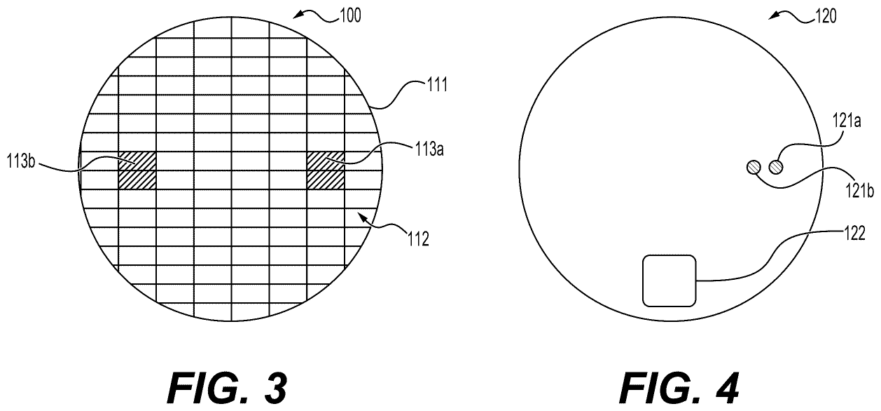

FIGS. 2a-2b show one example of an LLD system 100 according to the present invention, with FIG. 2a showing the LLD system 100 with a head 13 and a duct 10 in an engaged state and FIG. 2b showing the LLD system 100 with the head 13 and duct 10 in a disengaged state. FIG. 3 showing a bottom plan view of a stationary platform 110 housed in the head 13 and FIG. 4 showing a top plan view of a floating platform 120 housed in the duct 10. System 100 comprises a stationary platform 110 and a floating platform 120 received within a housing that includes a duct 10 having an internal volume 11 and a head 13 for closing an upper opening to the internal volume 11 of the duct 10. The duct 10 includes a plurality of perforations at a lower surface thereof. In a preferred example, as seen in FIG. 2b, the plurality of openings are provided in the form of a removable mesh screen attachment 7. The perforations in the lower surface are adapted for passage of the liquid 12 such that a liquid level L of the liquid 12 within the internal volume 11 of the duct 10 corresponds with a liquid level of the liquid 12 within the storage volume 4 of the container 1. Preferably, the duct 10 further comprises one or more openings proximate an upper region thereof, proximate the upper opening closed by the head 13, such that as liquid 12 enters/exits the internal volume 11 a corresponding volume of air may exit/enter the internal volume 11 to thereby maintain a balanced pressure within the internal volume 11. Stationary platform 110 is located at a fixed position proximate a top end of the internal volume 11 and floating platform 120 is received freely within the internal volume 11, below stationary platform 110, for floating proximate a surface of the liquid 12. Floating platform 120 is configured to project at least two focused lights (e.g., a laser-lights) onto a light-receiving surface of the stationary platform 110, and the stationary platform 110 is configured to detect light incident upon the light-receiving surface and to generate light-detection signals based on the same for use in calculating a height level L of the liquid 12.

Stationary platform 110 is configured for placement at a fixed position at a location proximate a top end of the internal volume 11 of the duct 10. Optionally, stationary platform 110 may be positioned at any of: a top end of the internal volume 11, a bottom side of the head 13, and/or at least partially embedded within a body of the head 13. Optionally, a tubular sleeve 9 may be provided to enable selective engagement and attachment of the head 13 for access to and/or removal of the stationary platform 110 housed therein. In such examples, the tubular sleeve 9 may have a first mating region 9a provided at the head 13 with external dimensions closely conforming to internal dimensions of a second mating region 9b of the duct 10 to provide a substantially fluid-tight seal between the head 13 and duct 10 while enabling selective engagement and disengagement of the head 13 without exposing the liquid 12 to an ambient environment. Inclusion of such a tubular sleeve 9 enables access to the stationary platform 110, for example, to recharge a power source thereof or to retrieve information on the container 1 with which the LLD system 100 is intended for use. For example, the container 1 may include coded data (e.g., serial code, barcode, QR code, etc.) identifying details of the container 1 (e.g., height, diameter, etc.) and/or the liquid stored therein (e.g., the type of liquid, material properties of the liquid, such as though not limited to viscosity, etc.) and the stationary platform 110 may include a sensor (e.g., an optical scanner) for scanning or otherwise receiving the coded data. This data may be used in the calculations of the liquid level height and/or for record keeping purposes.

For example, upon removing the head 13 from duct 10, the scanner on the stationary platform 110 may then be used to scan a barcode on an outside surface of the container 1 and a processor of the stationary platform 110 may then cross-reference data from the barcode with a database in which the data from the barcode is associated with properties of the container 1 and/or the liquid stored therein, and the processor may then download the corresponding container/liquid data to a local memory for use in subsequent calculations of liquid height for that specific container and liquid. In this way, by enabling the stationary platform 110 to retrieve specific container and/or liquid data from a database, LLD system 100 is thus adapted for use in measuring liquid height in multiple different types of containers that may store multiple different types of liquids. Preferably, the processor of the stationary platform 110 already has stored at a local memory. Preferably, the local memory of the LLD system 100 will be provided with information specific to the stationary platform 110 itself, such as the material construction thereof, the weight thereof (individual components and/or total) and data identifying a location of a float line of the LLD system 100. This LLD-specific information will be used in combination with the container/liquid information for calculation of the liquid height.

Stationary platform 110 is provided with an image sensor 119 having a light-receiving surface 111 at a bottom side thereof for the reception of projected light thereon, a light-sensing element 112 for detection of focused light 113 incident upon the light-receiving surface 111, and circuitry for generating and transmitting light-detection signals based on the detection of light incident upon the light-receiving surface 111. Stationary device 110 is further provided with a number of light-emitting devices 114 at a bottom side thereof for emitting light into the internal volume 11 of duct 10. Light-emitting devices 114 may be provided as one or more light-emitting diodes (LEDs). In examples in which a tubular sleeve 9 is provided to enable selective access to the stationary platform 110, a bottom surface of the first mating region 9a is provided as a clear lens 8a and a top surface of the second mating region 9b is provided as a diffused lens 8b. The diffused lens 8b provides a fluid-tight seal between the internal volume 11 and an outer atmosphere of the duct 10, and both lenses 9a/9b facilitate the transmission of light therethrough, in both directions. When head 13 and duct 10 are engaged via the tubular sleeve 9, the image sensor 119 sits atop the clear lens 8a of the tubular sleeve 9 to facilitate reception of focused light 113 onto the light-receiving surface 111.

In one example, the stationary platform 110 includes a printed circuit board (PCB) 115 that includes circuitry for establishing signal communication between the light-sensing element 112, a control unit 116 (processor), and a transceiver 117. PCB 115 may be constructed as a single monolithic structure or as a multi-component structure. For example, PCB 115 may be formed with multiple rigid boards each carrying certain elements (e.g., control unit 116 and transceiver 117 on one board and light-sensing element 112 on another board), with the rigid boards connected to one another by flexible circuits.

Image sensor 119 may be made with the light receiving surface 111 provided as a lens laying over the light-sensing element 112 with a fixed distance therebetween for calibrating measurements of the light incident upon the light receiving surface 111. The light-sensing element 112 may be provided as an image sensor with an M12 lens that detects incident light and communicates light-detection signals to the control unit 116 through the PCB circuitry. Light-sensing element 112 is configured to detect the specific location of individual lights incident upon the light-receiving surface 111 with high accuracy, which may be achieved, for example, by providing the light-sensing element 112 with an array of individual light detection pixels.

Control unit 116 is configured to control operations of stationary platform 110 and may be provided, for example, in the form of an ARM Cortex-M7 32-Bit Microcontroller with internal flash and RAM memory. Control unit 116 is configured to receive light-detection signals from the light-sensing element 112 and calculate a height level L of the liquid 12 based on the received light-detection signals. Control unit 116 is further configured to communicate output data, including the calculated liquid height level, to the transceiver 117 through the PCB circuitry, and the transceiver 117 is configured to communicate the output data to a remote system, such as a processing unit 140 and/or database 200. Transceiver 117 may be provided, for example, as a Murata-IZM Wi-Fi and Bluetooth BLE5 RF transceiver that enables communication via an internally mounted antenna.

The remote systems (e.g., processing unit 140 and/or database 200) may be provided with a processor configured to receive the light-detection signals and perform calculations for determining a liquid height level within container 1. Alternatively, control unit 116 may be provided with a processor configured for performing calculations for determining a liquid height level within container 1, and the remote systems may then receive the liquid height level calculated by the control unit 116.

Optionally, stationary platform 110 may further include one or more additional sensors, such as a temperature sensor and/or a pressure sensor, each of which are configured to communicate respective measurements (temperature, sensor, etc.) to control unit 116 via the first circuitry. In examples where stationary platform 110 is selectively removable from a tubular sleeve, the stationary platform 110 may further include an accelerometer and/or gyroscope for detecting and monitoring movement of the stationary platform 110. When such additional sensors are included, output data communicated from control unit 116 to transceiver 117 further includes data for measurements made by the respective sensors.

Stationary platform 110 is provided with a local power source 118, means for measuring a voltage level of the power source 118, and means for recharging the power source 118. For example, the power source 118 may be provided as an internal rechargeable high-capacity Li-ION battery and an integrated wireless Li-ION battery charger circuit may be provided to enable recharging of the Li-ION battery. Power source 118 provides power necessary for operation of the stationary platform 110, including activation of light-emitting devices 114 and operation of light-sensing element 112, control unit 116, transceiver 117, and any other sensors at the stationary platform 110.

Stationary platform 110 further includes an environmental enclosure that protects the stationary platform 110 from the contents of the container 10. The enclosure may be provided, for example, as a custom resin enclosure that is 3D printed onto the stationary platform 110.

Floating platform 120 is configured for placement within the liquid 12 received within the internal volume 11 of the duct 10 and adapted for floating proximate a surface of the liquid 12. Floating platform 120 is provided with at least one pair of focused light-projecting devices (e.g., laser lights) 121 that are each configured to project light upward through the internal volume 11 of the duct 10 and an ambient light sensor 122 that is configured to detect ambient light within the duct 10.

In one example, floating platform 120 includes a pair of focused light-projecting devices 121 in the form of a pair of red-dot laser lights 121. The pair of light-projecting devices 121 are configured such that a first light projecting device 121a is oriented to project a focused light directly upward at a 90° angle relative to an upper surface of the floating platform 120 with a second light-projecting device 121b oriented at a predetermined and fixed angle α, as measured relative to the orientation of the first light-projecting device 121a. Floating platform 120 further includes a power source 123 and means for recharging the power source 123. For example, power source 123 may be provided as an internal rechargeable high-capacity Li-ION battery and an integrated wireless Li-ION battery charger circuit may be provided to enable recharging of the Li-ION battery. Each of the light-projecting devices 121a/121b may have a dedicated current driver circuit for delivering power from the power source 123 to separately power the two light-projecting devices 121a/121b. A load switch is provided to control delivery of power from the power source 123 to the light-projecting devices 121a/121b via the driver circuits, with the load switch set at default to prevent delivery of power. Ambient light sensor 122 is configured to control activation of the load switch for enabling the delivery of power to the light-projecting devices 121a/121b through the driver circuits upon detection of an ambient light, with the ambient light sensor 122 adapted to trigger activation of the load switch upon detection of ambient light as emitted from the light-emitting devices 114 of stationary platform 110.

Floating platform 120 further includes an environmental enclosure that protects the floating platform 120 from the contents of the container 1. The enclosure may be provided, for example, as a custom resin enclosure that is 3D printed onto the floating platform 120.

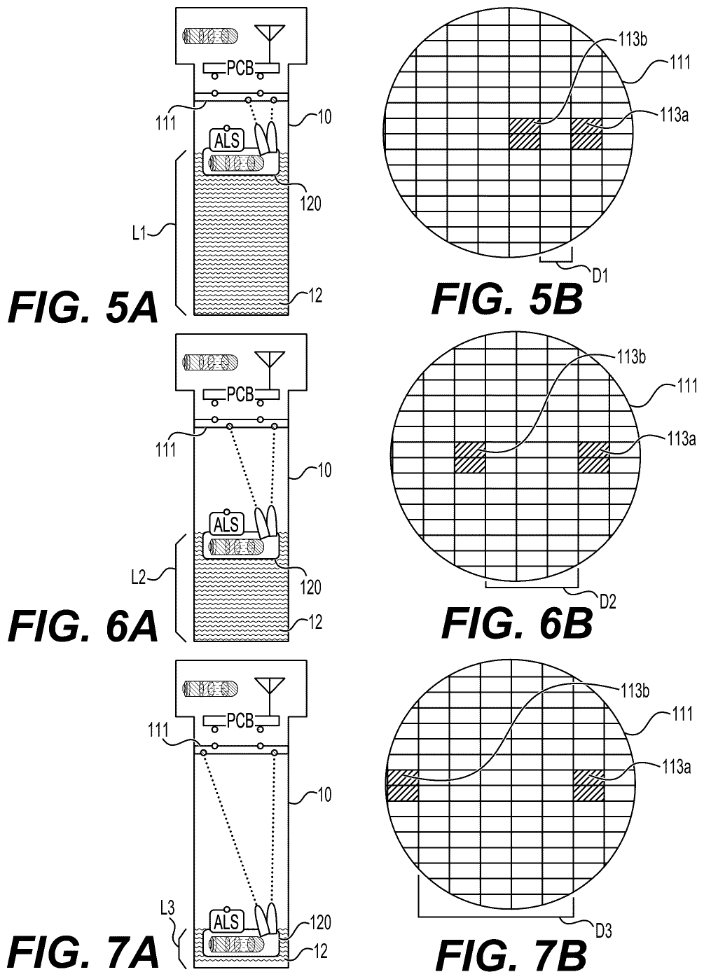

FIGS. 5a-7b show the system 100 in use, as illustrated at three separate moments in time, corresponding with three separate measurements of height level L of a liquid 12 held within a container 1. Control unit 116 of the stationary platform 110 periodically triggers delivery of power from the power source 118 to activate the light-emitting devices 114 to emit an ambient light downward into internal volume 11 of duct 10. The ambient light sensor 122 at floating platform 120 detects the ambient light emitted by LEDs 114 and triggers the load switch to enable delivery of power from power source 122 to the pair of focused light-projecting devices 121. Light-projecting devices 121a/121b project focused light upward into internal volume 11 to impinge light-receiving surface 111 of stationary platform 110. Light-sensing element 112 at light-receiving surface 111 detects the focused lights 113 incident upon light-receiving surface 111, with detection of a corresponding location for each of the individually focused lights 113a/113b. This may be achieved, for example, through the detection of color frequency differences and/or geometrical differences in color frequency measurements due to the incidence of colored laser light upon the light-receiving surface 111. Light-sensing element 112 communicates light-detection signals to control unit 116, and control unit 116 calculates a distance D between two locations where the focused lights 113a/113b impinge light-receiving surface 111.

With calculation of a distance D between locations of the impinging focused lights 113a/113b, the control unit 116 calculates a height level L of the liquid 12 using the following formula (1):

$$L = H - ( ( D / Tan α ) + δ ) \qquad ( 1 )$$

where, “H” is a predetermined height between the light-receiving surface 111 and a bottom of the internal volume 11 of duct 10; “D” is the calculated distance between the locations of the two focused lights 113a/113b detected on the light-receiving surface 111; “α” is the predetermined angle between the first and second light-projecting devices 121a/121b; and “δ” is an offset accounting for a difference between a float line of the floating platform 120 and a vertex point that defines the angle α between the laser lights projected from the light-projecting devices 121a/121b. The value of the offset height δ will be predetermined based on the dimensions and configuration of the floating platform 120. It is possible the offset height δ may be a zero-value (δ=0), for example, if the light-projecting devices 121a/121b are configured and oriented such that a vertex formed from the respectively projected laser lights would reside on a horizontal plane coinciding with the float line of the floating platform 120. As seen in FIG. 2a, the angle of incidence at which the focused light 113a of the first light-projecting device 121a impinges upon the light-receiving surface 111 is identified as β. When the first light-projecting device 121a is oriented to project a focused light 113a directly upward at a 90° angle relative to an upper surface of the floating platform 120, the angle β is then also 90°.

In some instances, there may be a slight error in the height level L calculated from formula (1) above. This may occur, for example, when a volume of the liquid 12 is sufficiently low that a bottom surface of the floating platform 120 contacts a bottom surface defining the internal volume 11, in which case the liquid 12 may then not rise to a height coinciding with the float line of the floating platform 120. Optionally, control unit 116 may be preprogrammed to recognize a distance D between the focused lights 113a/113b that is determined in advance to correspond with the floating platform 120 being at a maximum possible distance from the light-receiving surface 111 (e.g., corresponding with the floating platform 120 resting on a bottom surface defining the internal volume 11) and upon detecting this predetermined distance D to then output a signal conveying that the liquid height L is below a minimal threshold that equates to an approximately empty state. Float line values may be determined in advance through a calibration sequence in which floating platforms of different types of material are placed in a container with increasing amount of fluid incrementally added into the internal volume to identify the volume of the liquid that results in flotation of the floating platforms and float lines for the same. Results from these tests may be stored in the memory of the system and used to account for an “Error” offset of formula (1), enabling a minimization of the absolute error of the calculated height Level L in formula (1).

FIGS. 5a-7b illustrate a series of periodic measurements of a height level L of a liquid 12 in a container 1. At a first measurement, while a liquid height level L1 is relatively high (FIG. 5a), the light-projecting devices 121 are relatively close to light-receiving surface 111, resulting in a relatively short distance D1 between locations of the impinging focused lights 113a/113b (FIG. 5b). At a second measurement, when there is a lowered liquid height level L2 (FIG. 6a), the light-projecting devices 121 are further distanced from light-receiving surface 111, resulting in an increased distance D2 between locations of the impinging focused lights 113a/113b. At a third measurement, when there is a further lowered liquid height level L3 (FIG. 7a), light-projecting devices 121 are yet further distanced from light-receiving surface 111, resulting in a yet further increased distance D3 between locations of the impinging focused lights 113a/113b.

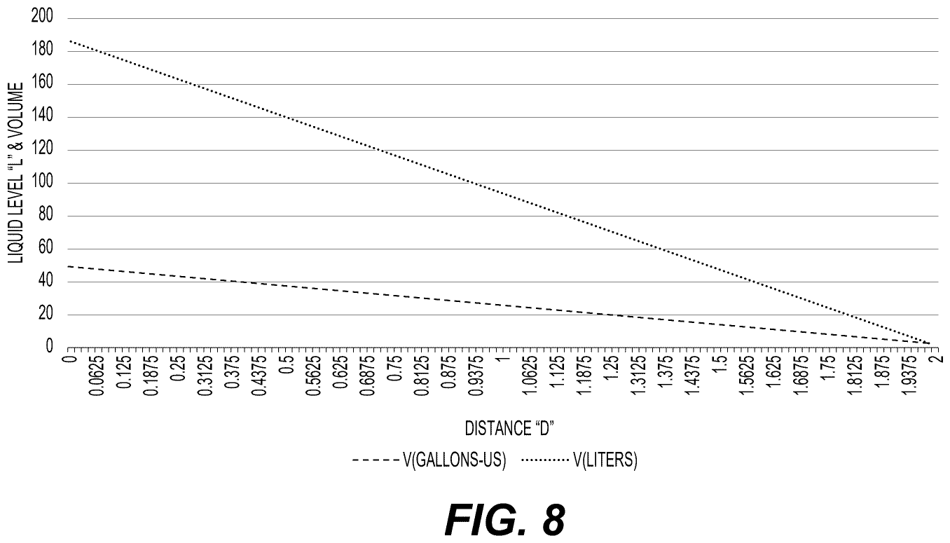

FIG. 8 shows a chart with measurement results from a working sample of an LLD system 100 according to the present invention. This working sample was prepared with a container 1 in the form of a barrel having an inner volume defined by a radius of 10 in (25.4 cm) and a maximum liquid level height of 36 in (91.44 cm). The LLD system 100 in this sample was configured with the light-projecting devices 121a/121b oriented with an angle α of 3.180° therebetween. The horizontal axis in the chart represents the distance D, corresponding with the measured distance D between two focused lights 113a/113b detected on the light-receiving surface 111 within duct 10; and the vertical axis in the chart represents both the height level L and the volume V of the liquid 12 within duct 10. Upon calculating a height level L according to formula (1) above, the liquid volume may then be calculated using the following formula (2):

$$V = π * {r}^{2} * L \qquad ( 2 )$$

where, “r” is a predetermined radius of the container 1 and “L” is the measured height level of liquid 12 within duct 10. As seen in FIG. 8, when a liquid 12 in the container 1 is at approximately maximum capacity, there is a measured distance D at the light-receiving surface 111 of approximately D=0 in, with a height level L of approximately L=36″ (91.44 cm) and a volume V of approximately V=11,309.73 in³ (48.960 gal.; 185.333 L). As liquid 12 is removed from the container 1, the measured distance D decreases, resulting in corresponding decreases to the height level L and volume V. Eventually, upon removal of substantially all liquid 12 from container 1, there is a measured distance D at the light-receiving surface 111 of approximately D=2 in, with a height level L of approximately L=0″ (0 cm) and a volume V of approximately V=0 in³ (0 gal.; 0 L).

Optionally, control unit 116 may be preprogrammed with one or more threshold height levels L′ and, upon calculating a liquid height level L, the control unit 116 may compare the calculated height level L to the one or more threshold height levels L′. If it is determined that a calculated height level L is below one or more threshold height levels L′, control unit 116 may then transmit one or more warning signals informing that container 1 needs to be resupplied or replaced. The transmitted warning signals may be included in the output data communicated to transceiver 117.

Optionally, if there is not any need to calculate an exact height (L) or volume (V) of the liquid 12 within container 1, then the LLD system 100 may instead be programmed to determine a fullness state of container 1 based on a distance D2 between a top surface of the floating platform 120 and a bottom surface of the image sensor 119 using the following formula (3):

$$D 2 = ( D / Tan α ) . \qquad ( 3 )$$

where, “D” is the calculated distance between the locations of the two focused lights 113a/113b detected on light-receiving surface 111 and “α” is the predetermined angle between the first and second light-projecting devices 121a/121b. When there is a minimum distance D of approximately D=0 in, there will then be a minimum distance D2, representing a substantially full state of container 1. When there is a maximum distance D of approximately D=2 in, there will be a maximum distance D2 representing a substantially empty state of container 1.

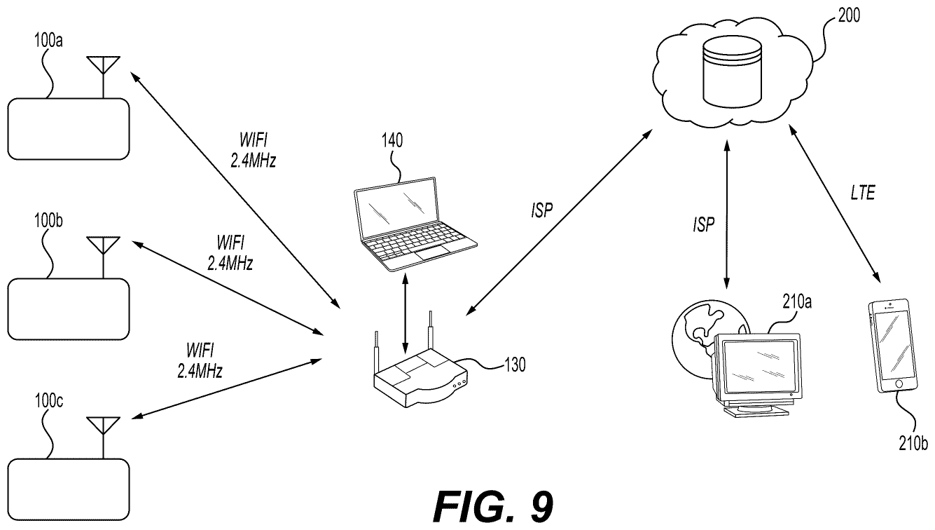

As shown in FIG. 9, a system 100 according to the present invention may communicate with a remote system (e.g., processing unit 140, database 200, etc.) for collection, storage, and analysis of output data from control unit 116. The output data may be communicated to a remote database 200, for example, via the internet through a routing device 130 (e.g., a Wi-Fi/Ethernet connection). Data stored at the remote database 200 may then be accessible through one or more remote user devices 210 (e.g., computer 210a, mobile device 210b, etc.). Optionally, routing device 130 may also communicate the output data directly to a workstation 140 at the local worksite of one or more containers 100a-100c. Routing device 130 may service multiple independent systems 100a-100c to monitor liquid height levels L in multiple containers 1 which may be at a common location or at multiple separate locations.

Though the present invention is described with reference to particular embodiments, it will be understood to those skilled in the art that the foregoing disclosure addresses exemplary embodiments only; that the scope of the invention is not limited to the disclosed embodiments; and that the scope of the invention may encompass any combination of the disclosed embodiments, in whole or in part, as well as additional embodiments embracing various changes and modifications relative to the examples disclosed herein without departing from the scope of the invention as defined in the appended claims and equivalents thereto.

To the extent necessary to understand or complete the disclosure of the present invention, all publications, patents, and patent applications mentioned herein are expressly incorporated by reference herein to the same extent as though each were individually so incorporated.

The present invention is not limited to the exemplary embodiments illustrated herein, but is instead characterized by the appended claims, which in no way limit the scope of the disclosure.

What is claimed is:

1. A system for detecting a liquid height level within a container comprising:
a stationary platform for positioning within a duct at a fixed position, the stationary platform comprising a light-receiving surface for reception of projected light thereon, a light-sensing element for detection of light incident upon the light-receiving surface, and circuitry for generating light-detection signals based on the detection of light incident upon the light-receiving surface,
a floating platform for positioning within the duct for floating at a surface level of a liquid within the duct, the floating platform comprising at least one pair of light-projecting devices for projecting light onto the light-receiving surface of the stationary platform, and
a processor configured to determine, based on the light-detection signals, a height level of the liquid in the duct.

2. The system of claim 1, wherein
the processor is configured to determine the liquid height level by determining, based on the light-detection signals, a distance between a first projected light incident on the light-receiving surface and a second projected light incident on the light-receiving surface.

3. The system of claim 2, wherein
the processor is configured to determine the liquid height level by determining, based on the distance between incidence of the first projected light and incidence of the second projected light, a distance between the stationary platform and the floating platform.

4. The system of claim 3, wherein
the processor is configured to determine the liquid height level by determining a difference between: (a) a predetermined height between the light-receiving surface and a bottom of an internal liquid storage volume, and (b) the determined distance between the stationary platform and the floating platform.

5. The system of claim 1, wherein
the floating platform comprises a light sensor configured for activating power to the at least one pair of light-projecting devices.

6. The system of claim 5, wherein
the stationary platform comprises a number of light-emitting devices for emitting light for detection by the light sensor at the floating platform to trigger activation of the at least one pair of light-projecting devices.

7. The system of claim 1, wherein
the processor is provided at a control unit at the stationary platform.

8. The system of claim 7, wherein
the processor is provided at a remote processing unit.

9. The system of claim 7, wherein
the stationary platform comprises a control unit configured to communicate output data comprising the light-detection signals to the remote processing unit.

10. The system of claim 9, wherein
the processing unit is configured for signal communication with control units of multiple stationary platforms in multiple containers.
